(19) United States
(12) Patent Application Publication
(10) Pub. No.: US 2026/0280480 A1
(43) Pub. Date: Sep. 17, 2026

(54) TRANSPARENT PROTECTIVE COVERAGE USING CONTINUOUS LAMINAR FLOW FOR SOLAR PANELS IN REMOTE PLATFORMS

(71) Applicant: Saudi Arabian Oil Company, Dhahran (SA)

(72) Inventors: Maha Nour, Thuwal (SA); Marwan Abdullah, Thuwal (SA); Brian Parrott, Thuwal (SA); Anas Bintin, Thuwal (SA)

(73) Assignee: Saudi Arabian Oil Company, Dhahran (SA)

(21) Appl. No.: 19/076,166

(22) Filed: Mar. 11, 2025

(51) Int. Cl. H02S 40/10; B08B 3/02; B08B 3/10

(52) U.S. Cl. CPC H02S 40/10; B08B 3/02; B08B 3/10; B08B 2203/027

(57) ABSTRACT

A method for maintaining efficiency and cleanliness of remote solar panels is provided. In some implementations, the method comprises sourcing water from a water source. In one or more implementations, the method includes pumping the sourced water onto one or more solar panels, each having a surface. In particular arrangements, the pumping is performed by a water pump controlled by a water pump control module. In various arrangements, the method also includes distributing the water across the one or more panel surfaces. In one or more variants, the distributing is performed by one or more water outlets connected to the water pump. In one or more variations, the one or more water outlets are controlled by the water pump control module to maintain a substantially transparent laminar flow sheet across the panel surface. A system for maintaining efficiency and cleanliness of remote solar panels is also disclosed.

### FIELD OF THE DISCLOSURE

The present disclosure relates generally to the field of energy generation and solar panel maintenance.

### BACKGROUND OF THE DISCLOSURE

Solar energy systems deployed in marine environments face challenges that compromise their efficiency and longevity. Photovoltaic (“PV” or “solar”) panels installed on offshore platforms are susceptible to various forms of contamination such as dust deposition, salt buildup, and bird or animal waste. These contaminants not only obstruct sunlight, reducing the effectiveness of energy conversion, but may also cause damage to the individual solar cells.

Traditional maintenance routines, involving laborious cleaning procedures, are inefficient for large arrays of panels. Conventional methods are also impractical due to the harsh environmental conditions and inaccessibility of these often-remote locations. In addition, infrequent cleaning schedules may lead to significant accumulation of debris, which, coupled with potential shading issues, can result in imbalanced cell operation and overall system degradation.

The present disclosure is directed to mitigate and resolve these concerns.

### SUMMARY OF THE DISCLOSURE

Methods and systems are disclosed herein for maintaining efficiency and cleanliness of remote solar panels. In some implementations, a method for maintaining efficiency and cleanliness of remote solar panels is provided. In particular arrangements, the method comprises sourcing water from a water source. In one or more implementations, the method includes pumping the sourced water onto one or more solar panels, each having a surface. In various arrangements, the pumping is performed by a water pump controlled by a water pump control module. In one or more variants, the method also includes distributing the water across the one or more panel surfaces. In one or more variations, the distributing is performed by one or more water outlets connected to the water pump. In some implementations, the one or more water outlets are controlled by the water pump control module to maintain substantially transparent a laminar flow sheet across the panel surface, wherein substantially transparent is at least 90-99.5% transparent. Light-blocking contaminants selected from the group consisting of dust, salt, bird/animal waste, marine organisms and combinations of two or more thereof are: cleaned from the one or more panel surfaces having water distributed thereon by the substantially transparent laminar flow sheet; and/or minimized from forming on the one or more panel surfaces having water distributed thereon by the substantially transparent laminar flow sheet. The substantially transparent laminar flow sheet cools the one or more panel surfaces having water distributed thereon to increase energy conversion efficiency.

In one or more implementations, the water source is a lake, a swamp, a mangrove, or a body of saltwater. In particular arrangements, the method further comprises regulating the water flowrate by the water pump control module connected to the one or more water outlets. In one or more variants, one or more water outlets comprise one or more of the following: a wide nozzle slit from which water is poured or flows across the width of the panel; a spray system that sprays onto a top portion of the panel or an area above the panel, from which water proceeds to flow over the panel; or a series of channels that direct small streams of water across a top portion of the panel or an attachment above the panel that serves to distribute water evenly across the width of the panel via flow channels or hydrophilic surfaces.

In one or more variations, the method step of regulating further comprises maintaining water flow below a predetermined Reynolds number for laminar flow. In various arrangements, the method further comprises filtering the water with a water filter connected to the water pump to remove particulates. In particular arrangements, the method step of filtering is performed prior to distributing water across the one or more panel surfaces. In some implementations, the method further comprises controlling the distribution of water, via the water pump control module, to maintain a hydrophilic coating on the one or more solar panels. In various arrangements, the one or more solar panel surfaces comprise non-reflective microtexture. In one or more variants, the solar panels are elevated above the water source, and it further comprises lifting sourced water to an elevation above the source of water with a water wheel mechanism.

In one or more implementations, a system for maintaining efficiency and cleanliness of remote solar panels is provided. In particular arrangements, the system comprises a water pump to source and pump water to one or more solar panels, wherein the one or more solar panels each have a surface. In some implementations, the system includes a water pump control module, wherein the water pump control module comprises a processor, a memory, and code executing in the processor. In various arrangements, the water pump control module is configured by the code executing in the processor to control the water pump. In one or more variants, the system includes one or more water outlets connected to the water pump, wherein the water outlets are configured to distribute the water across the surfaces of the one or more solar panels in a manner that maintains a substantially transparent laminar flow sheet across the panel surface. In one or more variations, the system comprises a water pressure sensor, wherein the water pressure sensor is configured to transmit signals to the water pump control module to maintain the substantially transparent laminar flow sheet across the one or more solar panel surfaces.

In one or more implementations, the system's water pump is configured to source water from various water sources including a lake, a swamp, a mangrove, or a body of saltwater. In particular arrangements, the system further comprises a water flowrate regulator incorporated into the water pump control module for regulating the flow of water through the one or more water outlets. In various arrangements, the system's water outlets comprise one or more of the following: a wide nozzle slit for creating a water flow across the width of the panel; a spray system for depositing water on a top portion of the panel; or a series of channels with flow channels or hydrophilic surfaces for directing small streams of water across a top portion of the panel. In one or more variants, the system's flowrate regulator maintains water flow at or below a predetermined Reynolds number indicative of laminar flow.

In one or more variations, the system further comprises a water filter connected to the water pump for removing particulates from the water before it is distributed onto the one or more solar panel surfaces. In some implementations, the system's water filter is positioned to filter water prior to the distribution across the one or more solar panel surfaces. In various arrangements, the system's water pump control module is further configured to control the distribution of water to maintain a hydrophilic coating on the one or more solar panels. In particular arrangements, the system's one or more solar panel surfaces include a non-reflective microtexture to enhance efficiency and cleanliness. In one or more implementations, the system further comprises a lifting mechanism, such as a water wheel mechanism, for elevating the sourced water to an elevation above the source, which is configured to support the solar panels erected above the water source.

The details of one or more implementations are set forth in the accompanying drawings and the description below. Other features will be apparent from the description, from the drawings, and from the claims.

### BRIEF DESCRIPTION OF THE DRAWINGS

The foregoing and other objects and advantages of the present disclosure will become more apparent when considered in connection with the following detailed description and appended drawings in which like designations denote like elements in the various views, in which:

FIG. 1 is a top-level diagram showing a water outlet mounted on top of a solar panel, from which a thin sheet of water flows to cover the surface of the panel according to certain embodiments.

FIG. 2 is a side view of the solar panel with a thin sheet of water flowing across it, which is emitted at the top and flows downward across the panel as a result of gravitational forces according to certain embodiments.

FIG. 3A depicts a flow sub-system including a wide nozzle slit according to certain embodiments.

FIG. 3B depicts a spray system according to certain embodiments.

FIG. 3C depicts a series of channels to direct small streams of water across a top portion of a panel according to certain embodiments.

FIG. 4 depicts microtextured solar panel coating to enable water to spread out uniformly across the panel in a thin layer according to certain embodiments.

FIG. 5 depicts use of a storage tank at an elevation above the solar panels along with sensors for monitoring according to certain embodiments.

### DETAILED DESCRIPTION OF CERTAIN EMBODIMENTS CONSISTENT WITH THE DISCLOSURE

Solar panels around the world operate in a variety of environments, many of which receive low amounts of rain and therefore require cleaning on a somewhat frequent basis. Of these, some exist in remote sea-water environments, where they are used, for example, to power platforms to safely extract hydrocarbons from reservoirs. While some of these platforms are easy to power via cables connected to traditional power sources, the costs to deploy power cables to remote platforms in the sea can be very high ($MM/km), suggesting there is unrealized value in the use of renewable energy such as photovoltaic (“PV”) cells along with batteries as an alternative to power cables. This alternative is particularly beneficial when the amount of power required can easily be met by a small array of solar panels.

Remote energy platforms often require power to communicate (often via radio) as well as to power control systems (e.g. SCADA systems) that need to be accessible during both the day and night. As such, when the platforms are powered via renewable, non-continuous power sources such as PV panels, they also frequently come with battery systems to provide continuous power. Unfortunately, in some environments, various issues can arise that dirty the surface of the panels and thus reduce their power generation as well as potentially harming the individual cells due to shading and the resultant imbalances in the system. Such issues can arise as a result of dust deposition, salt buildup, bird/animal waste, or the growth of marine organisms.

When the solar panels fail to generate sufficient power over a prolonged period, the associated batteries may over-discharge in order to keep the system running and can suffer irreversible damage that results in significant costs for replacement as well as ongoing downtime for the systems after sunset until the battery systems are replaced. Even in cases where the batteries do not fail, excessive discharge can dramatically reduce the lifetime of the batteries. As such, even a relatively short-term issue with the panels (a few days of significantly reduced output) can have a dramatic cost associated with it. Since these panels may be in remote areas in the sea (for example), and may suffer significant adverse weather conditions, it can be difficult to correct issues when they arise, due to, for example, rough seas and winds that prevent easy access to the remote platform. As a result, these batteries can be damaged quite frequently due to the inability to perform maintenance on the PV system before the batteries are damaged.

The present disclosure relates to enhancing the efficiency and operational reliability of solar panels on remote platforms, particularly in marine environments, through the use of a continuous laminar flow of water, such as seawater. By creating a thin protective sheet of water over the photovoltaic panels, systems and methods consistent with the present disclosure accomplish three tasks: it cleans the panel surface to prevent the accumulation of light-blocking contaminants including but not limited to one or more of dust, salt, bird/animal waste and marine organisms; it cools the panels to optimize their energy conversion efficiency; and it provides a transparent protective layer that shields the panels from further deposition of light-blocking contaminants. This laminar flow, maintained below the Reynolds number, ensures minimal turbulence allowing sunlight to effectively penetrate to the solar cells. The disclosure includes various methods for distributing the water, such as wide nozzles, spray systems, and channels, while innovative contributions like a hydrophilic surface coating and textured panel surfaces are proposed to enhance water flow and minimize reflection.

By utilizing readily available seawater, the system circumvents the high costs associated with traditional panel cleaning methods dependent on freshwater and reduces operational downtime due to contamination. This is especially advantageous for remote locations where maintenance access can be challenging during adverse weather. Additionally, the cooling effect of the flowing water mitigates temperature-induced inefficiencies in solar energy conversion, potentially enhancing overall power output. The disclosure addresses the risk of battery damage from insufficient solar power production—an issue exacerbated by environmental contaminants—by ensuring the panels remain clean and operational continuously. Overall, this method offers a sustainable and cost-effective solution to the challenges faced by solar energy infrastructures in harsh marine settings, promising improved efficiency and durability for renewable energy systems.

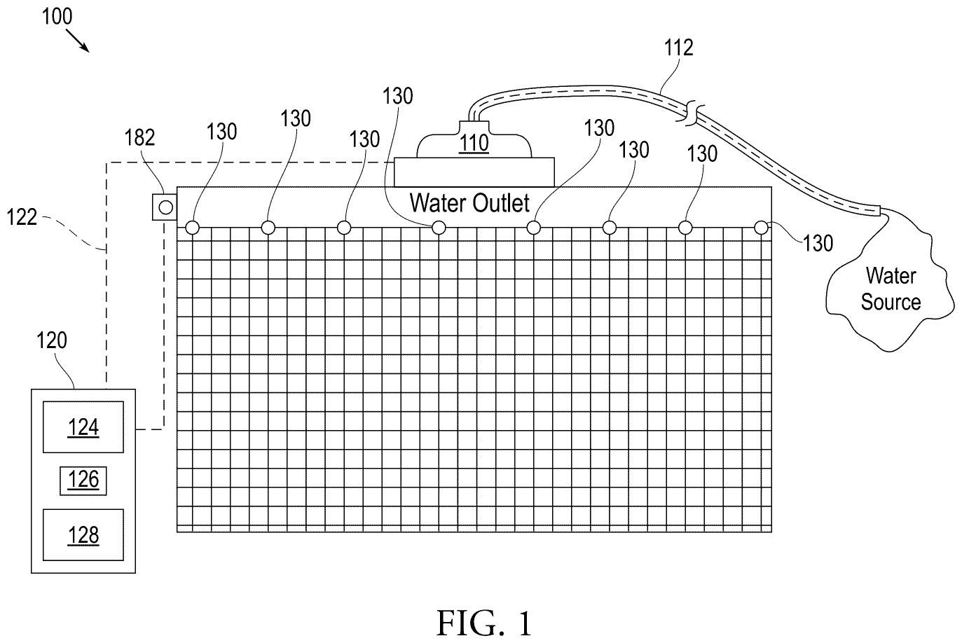

FIG. 1 is a top-level diagram 100 showing a water outlet mounted on top of a solar panel, from which a thin sheet of water flows to cover the surface of the panel during operation according to certain embodiments. In some implementations, a method for maintaining efficiency and cleanliness of remote solar panels is achieved by sourcing water from a water source. In one or more implementations, the sourced water is pumped onto one or more solar panels, each having a surface. In particular arrangements, the pumping is performed by a water pump 110 electrically connected (by, for example, electronic connection 122) to and controlled by a water pump control module 120 having a processor 124 and memory 128. The water is distributed across the one or more panel surfaces by one or more water outlets 130 connected to the water pump 110. In one or more variations, the one or more water outlets 130 are controlled by the water pump control module 120 to maintain a substantially transparent laminar flow sheet across the panel surface, wherein substantially transparent is at least 90-99.5% transparent. In certain implementations, the laminar flow sheet is not entirely uniform, exhibiting variations that can decrease reflections to enhance operational efficiency. While in one or more implementations the water layer achieves approximately 90% transparency, some reflections are present. This flow is designed to be continuous, effectively covering the entire solar panel surface during daylight operation, but can be optionally turned off at night to conserve power.

In one or more implementations, the system contains at least one water source with virtually unlimited supply (such as the sea) and one or more water outlets 130 on or near the solar panel that spread the water across the full active surface of the panel. In some implementations, the water source is another virtually unlimited source such as a lake, a swamp, a mangrove, a body of saltwater, or another type of body of water or water source. In various arrangements, the water pump 110 is configured to self-prime through an inlet hose 112 or pipe.

In one or more implementations, the method further comprises regulating a water flow rate by the water pump control module connected 120 to the one or more water outlets 130. Briefly, laminar flow is a type of fluid flow that occurs at low Reynolds numbers, while turbulent flow occurs at high Reynolds numbers. Laminar flow is a smooth, steady, and calm type of flow that occurs when viscous forces are dominant. In laminar flow, water particles flow in parallel layers in a straight line at a slow velocity. Turbulent flow, in contrast, is a chaotic, unsteady, and random type of flow that occurs when inertial forces are dominant. In turbulent flow, water particles collide with physical barriers and mix between parallel layers. The “Reynolds number” is a dimensionless number that describes the characteristics of fluid flow and defines the transition between lamina and turbulent flow. The Reynolds number is calculated using the equation:

$$Reynolds number = \frac{( density * diameter * velocity )}{viscosity} .$$

In applications consistent with the present disclosure, laminar flow occurs when the Reynolds number is less than approximately 2100. The transition from laminar to turbulent flow occurs when the Reynolds number is between approximately 2100 and 4000. When the Reynolds number is above approximately 4000, the flow is considered fully turbulent. In one or more implementations, features such as nozzle specifications, diameter, and flow rate, are subject to engineering design choices and are not restricted to any specific configuration.

In some implementations, the laminar flow of water creates a transparent or substantially transparent sheet of water on top of the solar panels, allowing sunlight to travel through the water layer to the photovoltaic panels, which convert photons into electrons. In some implementations, exemplary degrees of transparency for the substantially transparent laminar flow sheets are 90%, 95%, 99%, 99.5%, or other suitable percentages based on, for example, environmental conditions. In one or more implementations, this facilitates a system that can run for extended periods without dramatically decreasing the net energy produced by the panels by increasing efficiency through the cooling of the panels.

In some implementations, a system for maintaining efficiency and cleanliness of remote solar panels comprises a water pump 110 connected to a source via pipe or hose 112 and then to pump water to one or more solar panels. In one or more implementations, the one or more solar panels each have a surface. In particular arrangements, a water pump control module 120 comprises a processor 124, a memory 128, and code executing in the processor 124. In various arrangements, the water pump control module 120 is configured by the code executing in the processor 124 to control the water pump 110. In one or more variants, one or more water outlets 130 are connected to the water pump 110. In one or more variations, the water outlets 130 are configured to distribute the water across the surfaces of the one or more solar panels in a manner that maintains a substantially transparent laminar flow sheet across the panel surface. A water pressure sensor 182 is also present in one or more implementations of systems consistent with the present disclosure, and in some implementations the water pressure sensor 182 is capable of use as a flow-rate sensor or has an additional built-in flow rate sensor.

In some implementations, the water pressure sensor 182 is configured to transmit signals to the water pump control module 120 representative of pressure or flow rate to control the pump 110 to maintain the substantially transparent laminar flow sheet across the one or more solar panel surfaces. In one or more implementations, the water pump 110 is configured to source water from various water sources including a lake, a swamp, a mangrove, a body of saltwater, or other type of body of water. In particular arrangements, the system further comprises a water flow rate regulator 126 incorporated into the water pump control module 120 for regulating the flow of water through the one or more water outlets 130, in a feedback arrangement with the sensor 182.

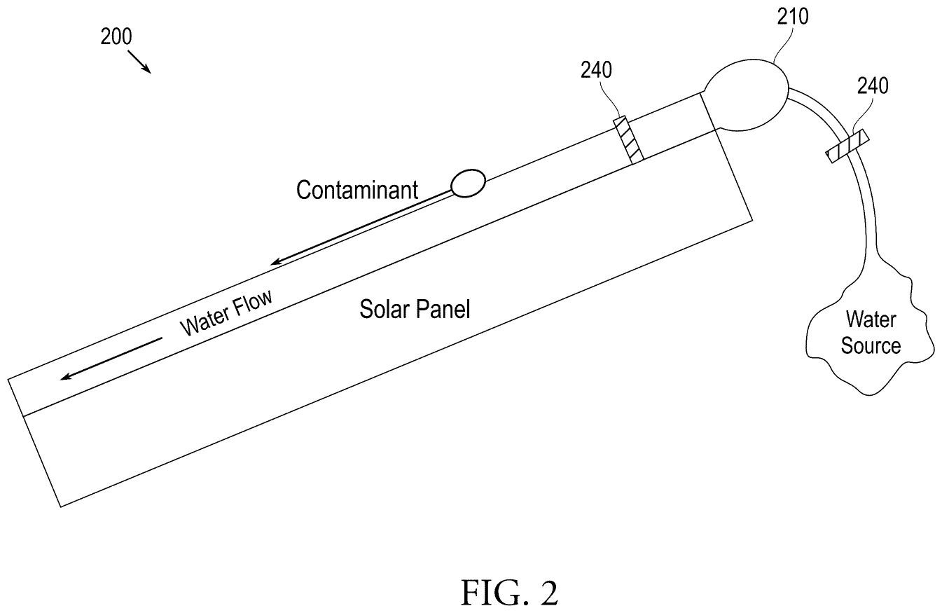

FIG. 2 is a side view 200 of the solar panel with a thin sheet of water flowing across it, which is emitted at the top and flows downward across the panel as a result of gravitational forces according to certain embodiments. In some configurations consistent with FIG. 2 and the present disclosure, the “contaminant” as depicted is prevented from interacting with and potentially sticking to the surface of the panel as the water creates a physical barrier between the contaminant and the solar panel.

In one or more variations, regulating the rate of water flow further comprises maintaining water flow below a predetermined Reynolds number for laminar flow: for example, a Reynolds number of 2100 or less, such as 2100, 2000, 1900, 1800, 1700, or any other practicable number configured to save power.

EXAMPLE APPLICATION INTRODUCTION: An example consistent with one or more implementations of the present disclosure is detailed in approximation below in order to show how the power gains coming from solar cleaning and cooling offset the pumping of water to accomplish that feat.

First, any hydrophilic coating present on the solar panels (as consistent with some implementations of systems disclosed herein) dramatically slows the flow of water and reduces the required water, while the temperature of the panels never fully reaches the temperature of the water during times of irradiance. Nevertheless, the exemplary calculations below show that the power cost (~40 W=20%) is reasonable compared to an otherwise uncleaned system in the absence of applications of the present disclosure that fail due to near total power loss, and, further, that at least some of that power can be regained through enhanced efficiency at the cooler temperatures.

### Example Assumptions

| | |
|---|---|
| Gravitational Constant | 10 m/s² (rounded for simplicity) |
| PV Panel Energy and Area | Single 200-Watt PV panel with 1 m² |
| | surface area |
| Scalability | Metrics can be scaled to multiple panels |
| Energy/Sq. Meter | 200-300 watts per square meter |
| Height of Panel Above | Approx. 2 meters above water source |
| Water | (e.g., the sea) |
| Water Layer Thickness | Panels coated in a 1 mm (0.001 m) |
| | layer of water |
| Water Rolloff Friction | Water slips (rolls) off panel with no |
| | friction (100% slip) |
| Panel Tilt | 30° tilt from horizontal |
| Water Temp. | 30° C. |
| Uncooled Panel Temp. | 70° C. |
| Cooled Panel Temp. | 30° C. |
| Conversion Efficiency | 0.5% conversion efficiency loss for each |
| Loss/Degree Increase | 1° C. increase |

### Example Calculations

| | |
|---|---|
| Volume of water needed | 0.001 m * 1 m² = 0.001 m³ |
| to coat panel | |
| Force accelerating water | ½ * 10 m/s² = 5 m/s² |
| on panel @ 30° | |
| Time for water to flow | 1 m = ½ * 5 m/s² * t² → t ≈ 0.6 s |
| 1 meter at this rate | |
| Water needed to keep 1 | 0.001 m³/0.6 s = 0.017 m³/s = 1.7 kg/s |
| cm sheet on panel | |
| Energy to lift 1 kg water | m * g * h = 1.7 kg * 10 m/s² * 2 m = 34 J |
| to solar panel | |
| Power requirement to lift | 1.7 kg/s * 20 J/kg = 34 Watts |
| water to the panel | |
| Power gained from | 200 W * ((70 − 30) * 0.5%) = 40 Watts |
| cooling panels | |
| Net power gain | 40 − 34 = 8 Watts |

EXPLANATION OF EXAMPLE CALCULATION RESULTS AND LIMITATIONS: In some implementations, the calculations above do not account for the increased transmittance resulting from cleaning the solar panels. In particular arrangements, it is assumed that a 1 mm layer of flow can be achieved and maintained, with the height of the panels positioned only 2 m above the water source. In one or more variants, losses due to the reflectivity of the water layer are not considered; however, one workaround in some implementations involves texturing a solar panel to create an anti-reflective surface on the water.

Overall, exemplary calculations above demonstrate the feasibility of operating systems consistent with the present disclosure on a nearly continuous basis during times of solar irradiance, thereby serving as a shield against contamination. In various arrangements, modifications of factors to improve the exemplary calculation above involve employing passive means to lift the water up to the solar panel height, such as capillary action. In one or more variations, reducing the flow of water across the surface decreases the quantity of water needed per second. In one or more implementations, ensuring that the panel is efficiently cooled by the water flow further optimizes cleaning, cooling, and conversion. In multiple implementations, code executing in the control module 120 processor 124 (from FIG. 1) and stored in memory 128 is configured to realize the metrics and values represented in the exemplary calculations above in order to achieve a desirable Reynolds number to maintain laminar flow over the one or more solar panels.

In some implementations, some methods and systems consistent with the present disclosure further comprise filtering the water one or more water filters 240 connected to the water pump 210 (like water pump 110 in FIG. 1) to remove particulates or contaminants. In one or more implementations, filtering with a water filter 240 is performed prior to distributing water across the one or more panel surfaces. In particular arrangements, the method further comprises controlling the distribution of water, via the water pump control module 110, to maintain a hydrophilic coating on the one or more solar panels.

In some implementations, a flowrate regulator (such as flowrate regulator 126 from FIG. 1 within control module 120) maintains water flow at or below a predetermined Reynolds number indicative of laminar flow, such as maintaining a Reynolds number of 2100 or less. In one or more implementations, some systems and methods consistent with the present disclosure further comprise a water filter 240 connected to the water pump 210 (or water pump 110 as in FIG. 1) for removing particulates from sourced water before it is distributed onto the one or more solar panel surfaces. In particular arrangements, the water filter 240 is positioned to filter water prior to the distribution across the one or more solar panel surfaces.

Corrosion or deposits of sun-blocking salt films is accounted for in some implementations, because some applications consistent with the present disclosure involve panels that are exposed to these elements on a regular basis and are designed to be resistant to the salt-water-related corrosion. While the deposition of sun-blocking salt films is typically an issue for standard cleaning solutions (e.g. those that do not maintain a layer of water nearly continuously), the use of near-continuous or fully continuous flow over the panels in some implementations consistent with the present disclosure overcomes this issue as deposits only occur when the system is stopped (e.g. at night, when the sun is not shining). Moreover, such deposits are quickly washed away as soon as the system restarts the next day, preventing any significant buildup that impacts solar conversion and energy generation over time.

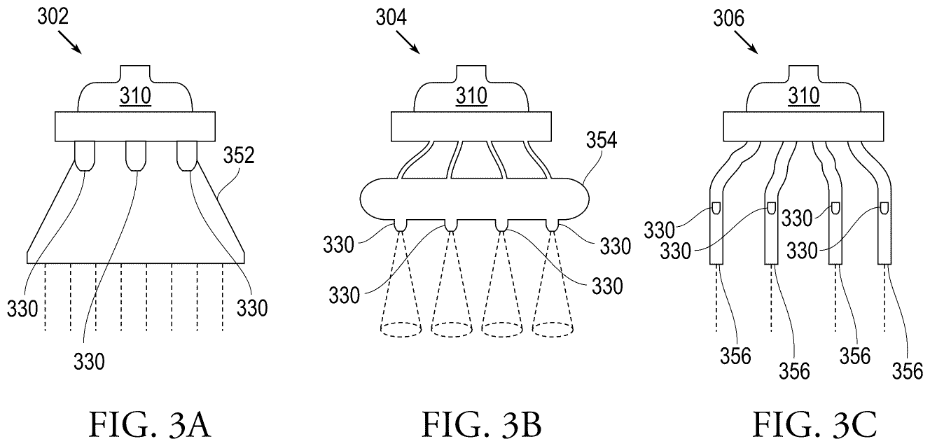

FIG. 3A depicts a flow sub-system including a wide nozzle slit 302 according to certain embodiments. FIG. 3B depicts a spray system 304 according to certain embodiments. FIG. 3C depicts a series of channels 306 to direct small streams of water across a top portion of a panel according to certain embodiments. Each of FIGS. 3A, 3B, and 3C depict various types of water outlets 330 with water pumps 310 (similar to water pump 110 in FIG. 1) for use in one or more methods and systems consistent with the present disclosure.

In particular arrangements, the water outlets 330 comprise a combination of one or more of the following: a wide nozzle 352 from which water is poured or flows across the width of the panel. In various arrangements, the water spray nozzle comprises a wide nozzle slit to create the uniform sheet of water.

In various arrangements, a spray system 354 sprays onto a top portion of the panel or an area above the panel, from which water proceeds to flow over the panel.

In one or more variants, a series of channels 356 direct small streams of water across a top portion of the panel or an attachment above the panel that serves to distribute water evenly across the width of the panel via flow channels 356 or hydrophilic surfaces. In various arrangements, a water pump control module (such as water pump control module 120 in FIG. 1) is further configured to control the distribution of water across a solar panel to maintain a hydrophilic coating on the one or more solar panels. In one or more variants, using a hydrophilic coating decreases the required thickness of a pumped water layer.

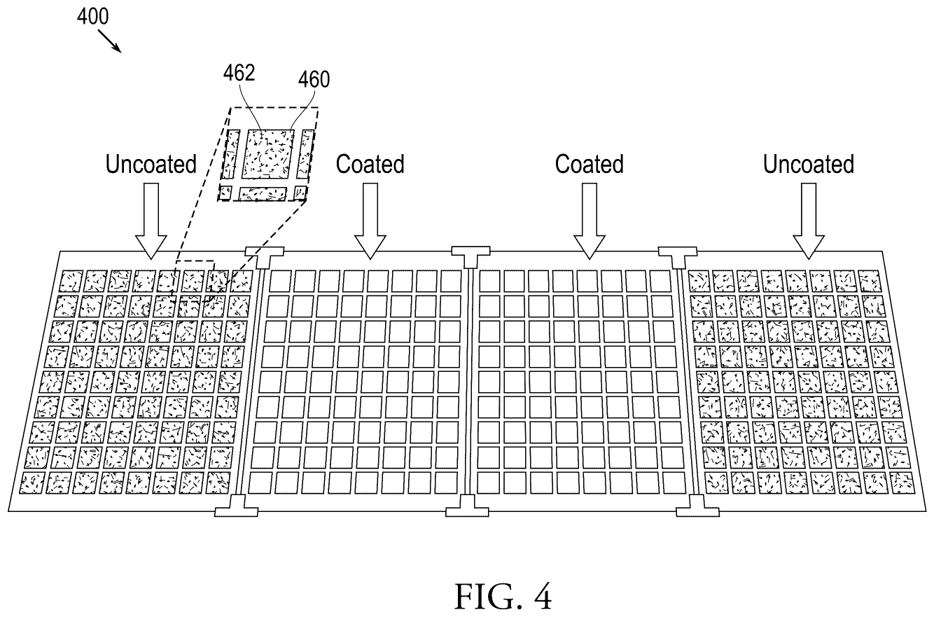

FIG. 4 is a depiction 400 of microtextured solar panel coating (far left and far right panels) to enable water to spread out uniformly across the panel in a thin layer according to certain embodiments. In one or more variants, the one or more solar panel surfaces comprise a non-reflective micro-texture 460. In particular arrangements, adding texture 460 to a panel surface reduces reflections through ripples in the water, enhancing solar energy conversion efficiency. In some implementations, the application of a highly hydrophilic coating 460 enables water to spread uniformly across the panel in a very thin layer, thereby reducing the amount of water needed to create a protective shield of water. In particular arrangements, this coating 460 slows the flow of water down the panel, thereby decreasing the overall flow required and significantly reducing energy requirements. Additionally, the degree of hydrophilicity can be tailored based on the specific engineering design requirements, with increased hydrophilicity being desirable for implementations where panels are mounted at steeper angles to ensure uniform water distribution across the surface. This adaptability allows for optimization of the coating properties to enhance performance under varying conditions.

In one or more variations, the coating 460 contains titanium dioxide or other similar photoactive catalysts to assist in the breakdown of organic contaminants on the panel's surface. TiO2 is known to be super-hydrophilic under UV irradiation. In various applications consistent with use of systems and methods disclosed herein, the coating 460 is reapplied at regular intervals, accounting for microtexture coatings that do not have a long lifespan. In one or more implementations, coating 460 is applied by spray, lacquering, painting, or other similar mechanisms. In one or more implementations, the surface of the solar panel is microtextured to create a pattern of very small ripples or bumps 462, which are anti-reflective. This texture 462 reduces the reflection of sunlight from the surface of the panel and slows down the flow of water, thereby reducing the energy costs associated with maintaining the layer. In some implementations, coatings like microtexture 460 or other hydrophilic coating last several years with minimal impact on panel efficiency. In particular arrangements, similar coatings are utilized as anti-reflective layers that enhance panel performance. In one or more variations, a hydrophilic coating can be easily applied by cleaning the panel and spraying on a new layer.

In some implementations, the drying times of the panels vary based on the power requirements for pumping water and operating other devices in the system. For example, if the panels are elevated significantly, lifting water may require more energy, necessitating a reduction in protective time. In one or more implementations, a thin film of salt deposits is likely to form whenever the system halts, so multiple systems and methods consistent with the present disclosure only stop the flow of water when the sun is low enough that the panels do not generate enough power to maintain the protective film. In particular arrangements, for instance, if birds roost above the panels at sunset, the protective film should ideally be sustained, even if stored battery power is required.

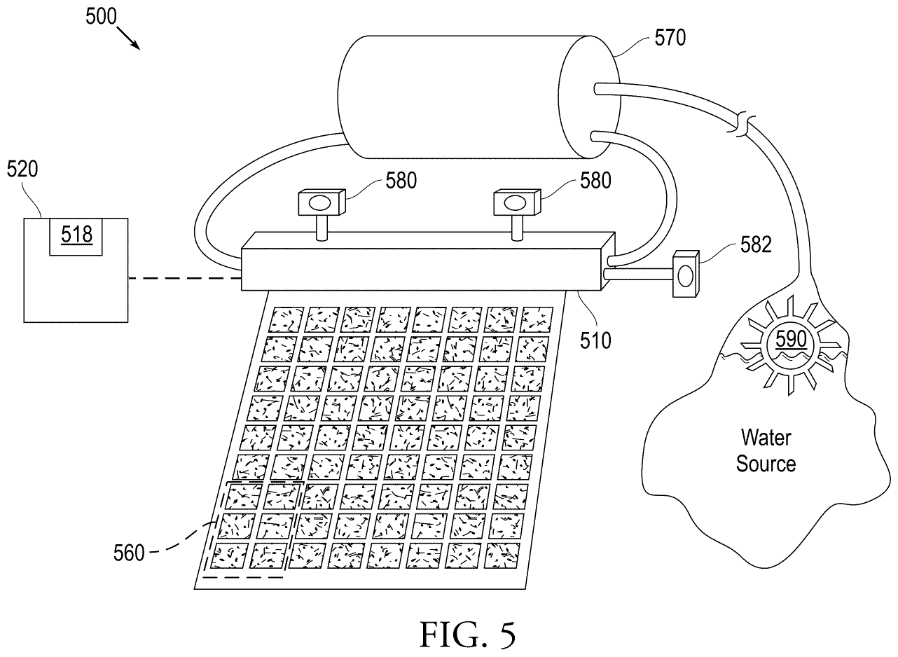

FIG. 5 is a diagram 500 of use of a storage tank 570 at an elevation above the solar panels along with sensors 580 (such as water pressure sensors and cameras) for monitoring according to certain embodiments. In some implementations, a storage tank 570 is positioned at an elevation above the solar panels to store excess water during times of high power production. Such an implementation reduces peak loads on the system while allowing for a constant water flow. In one or more variants, a large water tank 570 also serves as a backup power supply, enabling the pump to run in reverse, generating a small amount of power in case critical power levels are reached.

In one or more implementations, an electronic control system 518 (such as one integrated within control module 520, which is analogous to control module 120 from FIG. 1) is electronically connected to sensors 580 and other electronic components of systems and methods disclosed herein, such as control module 520 and water pressure sensor 582 (similar to water pressure sensor 182 as depicted in FIG. 1). Electronic control system 518, in some implementations, is further configured to redirect power to the water supply pump 510 (similar to water pump 110 in FIG. 1) based on the availability of energy from the system. In particular arrangements, since one of the primary functions of the system is recharging batteries, a smart algorithm is implemented within electronic control system 518, which contains or has electronic access to a processor having a memory and configured to execute code. This algorithm is configured to analyze various parameters, such as power output from the panels, charge needed at the batteries, temperature of the system, time, and more, in order to dynamically balance different power priorities.

In some implementations, the system utilizes a sensor 580 monitoring system (e.g., a camera) to determine when protection (e.g., for birds above the panel) or cleaning is necessary. Implementations such as this optimize the use of energy and ensure the productivity of the system.

In one or more variations, the solar panels are elevated above the water source, operation of the system further comprises lifting sourced water to an elevation above the source of water with a water wheel mechanism 590. In one or more variants, the water is raised using a water wheel 590 (or a similar mechanism) driven by water currents, wave action, or wind. In one or more implementations, systems and methods consistent with the present disclosure utilized a water wheel mechanism 590 to lift water with minimal energy to eliminate or reduce the need for pumping energy expended during use of a water pump 510 (similar to water pump 110 in FIG. 1).

In one or more arrangements, lifting mechanisms 590 are constructed from materials resistant to corrosion, similar to those used in offshore platforms and systems and methods consistent with the present disclosure. This involves but is not limited to specialized grades of marine steel, aluminum, or non-metallic materials treated to resist UV damage. In various arrangements, where capillary flow is employed, the capillaries are in some cases made of glass encased in protective materials surrounding a bundle of capillaries. In one or more variations, maintenance for moving systems is necessary every few years to replace specific components (e.g., bearings).

Systems and methods consistent with the present disclosure present the surprising benefit of using continuous (or semi-continuous) laminar flow of water over solar panels that acts as a transparent protective coverage layer to prevent light-blocking accumulations. This differs dramatically from a system that is used to clean or cool the panels only as needed. Preexisting water desalination options can filter salt, but they are energy intensive and represent a significant parasitic load on the system, so the systems and methods disclosed herein present distinct advantages. Additionally, a protective sheet of water consistent with the present disclosure is more successful in keeping the panels clean of particularly sticky contaminants instead of trying to remove the contamination after the fact. A substantially transparent laminar flow sheet consistent with the present disclosure enhances the cooling advantage to the solar panels, and the cooling water also acts as a heat sink to continuously reduce a panel's temperature and improve efficiency. Systems and methods herein employ continuous or semi-continuous seawater laminar flow for multiple purposes including cooling of, cleaning of and prevention of accumulation of light-blocking contaminants including but not limited to one or more of dust, salt, bird/animal waste and marine organisms.

In various arrangements, since some light-blocking contaminant accumulation is dissolvable salts, the concentration of salt in the water will rise until it forms a film on the panels. This phenomenon occurs because there is no outlet to prevent the continuous increase of salt concentration, even as other light-blocking contaminant(s) is/are removed from the panels. In some implementations, maintaining a near-continuous flow during sunlight exposure represents an innovative solution to the problem of salt build-up. Systems and methods consistent with the present disclosure tolerate salt accumulation overnight and utilizes saltwater itself to remove lingering deposits. An interesting phenomenon is that when water flows over the heated panel, its temperature rises, increasing the solubility of salt. In one or more implementations, this accelerated solubility results in the dissolution of lingering deposits more quickly when the flow resumes in the morning. In particular arrangements, while some filtration and recirculation are beneficial, it is crucial not to create a closed loop that allows for evaporation, leading to increased salt concentrations that could eventually cause issues.

It is to be understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A method for maintaining efficiency and cleanliness of remote solar panels, comprising:
sourcing water from a water source;
pumping the sourced water onto one or more solar panels each having a surface,
wherein the pumping is performed by a water pump having a water pump output controlled by a water pump control module; and
distributing the water across the one or more panel surfaces,
wherein the distributing is performed by one or more water outlets connected to the water pump,
wherein the one or more water outlets are controlled by the water pump control module to regulate a water flowrate through the one or more water outlets, and to dynamically adjust the water pump output based on signals from a water pressure sensor positioned to detect flow conditions across the one or more panel surfaces, to thereby maintain a substantially transparent laminar flow sheet across the panel surface,
wherein substantially transparent is at least 90-99.5% transparent,
wherein light-blocking contaminants selected from the group consisting of dust, salt, bird/animal waste, marine organisms and combinations of two or more thereof are
cleaned from the one or more panel surfaces having the water distributed thereon by the substantially transparent laminar flow sheet
and/or
minimized from forming on the one or more panel surfaces having the water distributed thereon by the substantially transparent laminar flow sheet;
and
wherein the substantially transparent laminar flow sheet cools the one or more panel surfaces having the water distributed thereon to increase energy conversion efficiency.

2. The method of claim 1, wherein the water source is a lake, a swamp, a mangrove, or a body of saltwater.

3. (canceled)

4. The method of claim 1, wherein the one or more water outlets comprise one or more of:
a wide nozzle slit from which water is poured or flows across the width of the panel;
a spray system that sprays onto a top portion of the panel or an area above the panel, from which water proceeds to flow over the panel; or
a series of channels that direct small streams of water across a top portion of the panel or an attachment above the panel that serves to distribute water evenly across the width of the panel via flow channels or hydrophilic surfaces.

5. The method of claim 1, wherein the regulating further comprises maintaining water flow below a predetermined Reynolds number for laminar flow.

6. The method of claim 1, further comprising filtering the water with a water filter connected to the water pump to remove particulates.

7. The method of claim 6, wherein the filtering is performed prior to the distributing the water across the one or more panel surfaces.

8. The method of claim 1, further comprising controlling the distributing the water, via the water pump control module, to maintain a hydrophilic coating on the one or more solar panels.

9. The method of claim 1, wherein the one or more solar panel surfaces comprise non-reflective microtexture.

10. The method of claim 1, wherein the one or more solar panels are elevated above the water source, further comprising lifting the sourced water to an elevation above the water source with a water wheel mechanism.

11. A system for maintaining efficiency and cleanliness of remote solar panels, the system comprising:
a water pump to source and pump water to one or more solar panels,
wherein the one or more solar panels each have a surface;
a water pump control module,
wherein the water pump control module comprises a processor, a memory, and code executing in the processor,
wherein the water pump control module is configured by the code executing in the processor to control the water pump;
one or more water outlets connected to the water pump,
wherein the water outlets are configured to distribute the water across the surfaces of the one or more solar panels in a manner that maintains a substantially transparent laminar flow sheet across the panel surface, wherein substantially transparent is at least 90-99.5% transparent, and;
a water pressure sensor,
wherein the water pressure sensor is configured to transmit signals to the water pump control module to maintain the substantially transparent laminar flow sheet across the one or more solar panel surfaces.

12. The system of claim 11, wherein the water pump is configured to source water from various water sources including a lake, a swamp, a mangrove, or a body of saltwater.

13. The system of claim 11, further comprising a water flowrate regulator incorporated into the water pump control module for regulating the flow of water through the one or more water outlets.

14. The system of claim 13, wherein the water outlets comprise one or more of:
a wide nozzle slit for creating a water flow across the width of the panel;
a spray system for depositing water on a top portion of the panel; or
a series of channels with flow channels or hydrophilic surfaces for directing small streams of water across a top portion of the panel.

15. The system of claim 13, wherein the flowrate regulator maintains water flow at or below a predetermined Reynolds number indicative of laminar flow.

16. The system of claim 11, further comprising a water filter connected to the water pump for removing particulates from the water before it is distributed onto the one or more solar panel surfaces.

17. The system of claim 16, wherein the water filter is positioned to filter water prior to the distribution across the one or more solar panel surfaces.

18. The system of claim 11, wherein the water pump control module is further configured to control distribution of water to maintain a hydrophilic coating on the one or more solar panels.

19. The system of claim 11, wherein the one or more solar panel surfaces include a non-reflective microtexture to enhance efficiency and cleanliness.

20. The system of claim 11, further comprising a lifting mechanism, such as a water wheel mechanism, for elevating the sourced water to an elevation above the source, configured to support the solar panels erected above the water source.
